(19) United States
(12) Patent Application Publication
(10) Pub. No.: US 2018/0058186 A1
(43) Pub. Date: Mar. 1, 2018

(54) SYSTEMS AND METHODS FOR COATED SALTS

(71) Applicant: General Electric Company, Schenectady, NY (US)

(72) Inventors: Mahendra L. Joshi, Oklahoma City, OK (US); Ryan Antle, Oklahoma City, OK (US); Catherine James, Oklahoma City, OK (US); Edward Steele, Oklahoma City, OK (US); Brian Rovelli, Oklahoma City, OK (US)

(21) Appl. No.: 15/252,639

(22) Filed: Aug. 31, 2016

(51) Int. Cl. E21B 43/40; E21B 43/26; E21B 43/267; E21B 33/13; B07B 1/00

(52) U.S. Cl. CPC E21B 43/40; E21B 43/26; C02F 2103/10; E21B 33/13; B07B 1/00; E21B 43/267

(57) ABSTRACT

A method in one embodiment includes obtaining produced water from at least one of drilling, completion, or hydrocarbon production. The method also includes separating the produced water into desalinated water and produced salt. Further, the method includes coating the produced salt with resin to provide coated produced salt.

### BACKGROUND

Considerable quantities of salt water may be produced by or result from oil or gas drilling, completion, and/or production processes. However, due to the large volume of solid waste (salts) that would result from desalination of the salt water resulting from drilling, the salt water is generally disposed of, instead of being processed.

### BRIEF DESCRIPTION

In one embodiment, a method is provided that includes obtaining produced water from at least one of drilling, completion, or hydrocarbon production. The method also includes separating the produced water into desalinated water and produced salt. Further, the method includes coating the produced salt with resin to provide coated produced salt.

In another embodiment, a method is provided that includes obtaining a coated produced salt. The coated produced salt includes a resin that coats a produced salt originating from at least one of an initial drilling, an initial completion, or an initial hydrocarbon production process. The method also includes using the coated produced salt for at least one of a subsequent drilling process, a subsequent completion, or subsequent hydrocarbon production process being performed in at least one of a same formation, site, or facility as at least one the initial drilling process, the initial completion process, or the initial hydrocarbon production process.

In another embodiment, a system is provided that includes a desalination unit, a water storage tank, a salt storage tank, and a coating unit. The desalination unit is configured to receive produced water from at least one of drilling, completion, or hydrocarbon production and to separate the produced water into desalinated water and produced salt. The water storage tank is configured to store the desalinated water. The salt storage tank is configured to store the produced salt. The coating unit is configured to apply a resin coating to the produced salt to provide coated produced salt. The desalination unit and the coating unit are disposed in at least one of a common site or facility.

### BRIEF DESCRIPTION OF THE DRAWINGS

FIG. 1 provides a flowchart of a method in accordance with various embodiments.

FIG. 2 provides a schematic depiction of a process for providing a resin coated salt in accordance with various embodiments.

FIG. 3 provides a schematic depiction of a system for coating a produced salt with resin in accordance with various embodiments.

FIG. 4 provides a schematic depiction of proppant within a fracture of a formation in accordance with various embodiments.

FIG. 5 provides a schematic depiction of cement used with a wellbore in accordance with various embodiments.

FIG. 6 is a schematic diagram of a system formed in accordance with various embodiments.

### DETAILED DESCRIPTION

Various embodiments will be better understood when read in conjunction with the appended drawings. To the extent that the figures illustrate diagrams of the functional blocks of various embodiments, the functional blocks are not necessarily indicative of the division between physical components. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Generally, various embodiments provide, for example, for desalination of salt water produced during a drilling, completion, and/or hydrocarbon production process and/or beneficial use of salts generated by such a desalination. Various embodiments provide high treated water recovery from saline produced water, which provides precipitated salts as a byproduct. The salts in various embodiments are used as aggregates, or as additives to traditional proppant. For example, fracture completions incorporate proppants (e.g., sand, ceramics) of various shapes, sizes, and composition added to a hydraulic fracture fluid. By using coated produced salts as an additive to the hydraulic fracture fluid, the produced salts may be used or conveniently disposed of. The disposal of salt in deep hydrocarbon bearing formations is environmentally sustainable due to minimum impact on aquifers or groundwater storage. The salts in various embodiments are provided with a passivating binder, or polymer or resin coating (such as epoxy or phenolic resins). The coating may be applied using one or more techniques such as vapor deposition, use of liquid binders, or spray coating, among others. In various embodiments, the coating improves stability of the salts by helping maintain fracturing fluid chemistry and maintain fracture stimulation performance (e.g., by improved fluid permeability and conductivity) during well completion or hydraulic fracturing, flow-back, and production.

At least one technical effect of various embodiments includes improved water recovery from drilling, completion and/or hydrocarbon production processes. At least one technical effect of various embodiments includes reduced costs or inconvenience required for disposal of salt water and/or salts resulting from drilling, completion and/or hydrocarbon production processes. At least one technical effect of various embodiments includes use of produced salts for beneficial purposes at a drilling, completion and/or hydrocarbon production location (e.g., in connection with one or more of fracturing fluid, cement, or drilling mud).

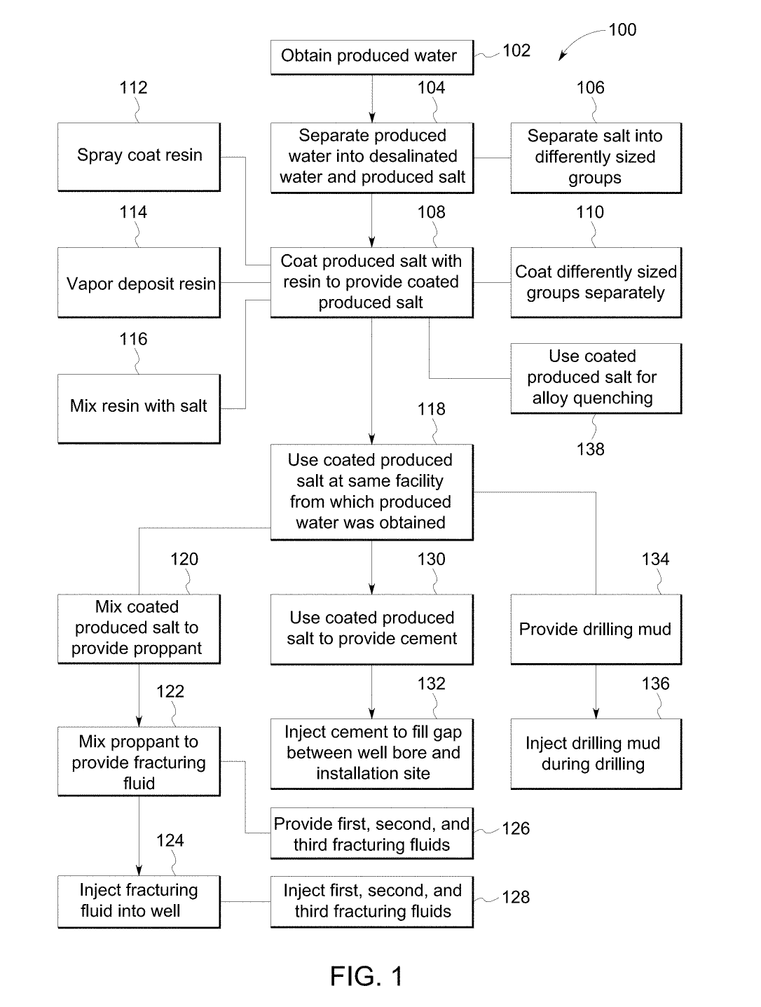

FIG. 1 provides a flowchart of a method 100 in accordance with various embodiments. In various embodiments, the method 100, for example, employs structures or aspects of various embodiments (e.g., systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 100 are used as one or more algorithms to direct hardware to perform operations described herein (e.g., in conjunction with an automated control process implementing one or more aspects of the method 100). In various embodiments, one or more processors uses portions, aspects, and/or variations of the method 100 as one or more algorithms for process control.

At 102, produced water is obtained from at least one of drilling, completion, or hydrocarbon production. Produced water may be obtained, for example, from a drilling process to open or expand a well. As another example, produced water may be obtained during completion actives to stimulate a well. As one more example, produced water may be obtained from a hydrocarbon production process that results in the removal of oil and/or gas, along with produced water. As used herein, produced water includes water as well as salts (and/or additional minerals). For example, produced water obtained during a drilling, completion, or production process may include water from ancient seas. The salts forming a part of the produced water may include one or more of Sodium Chloride, Calcium Sulfate, Calcium Chloride, Sodium Bicarbonate, Sodium Sulfate, Calcium Carbonate, or other salts or minerals.

At 104, the produced water is separated into desalinated water and produced salt. In various embodiments, one or more desalination or crystallization techniques may be employed. Techniques known to those having ordinary skill in the art may be used for desalination or crystallization. Examples of such techniques include solar desalination, multi-stage or multi-pass flashing, distillation, mechanical vapor-compression, ion exchange, membrane techniques such as reverse osmosis or forward osmosis, other membrane techniques, or freezing, among others. The desalinated water may be used on the same drilling site from where it was obtained for various different purposes, including use in mixing proppant, cement, or drilling mud. It may be noted that various conventional techniques require the expense and effort to dispose of the salts and/or minerals produced by desalination; however, various embodiments disclosed herein in contrast avoid or reduce disposal cost and utilize the salts or minerals produced for beneficial purposes.

At 106, the salt is dried and sized into different groups. It may be noted that the different groups may be defined by a range of sizes (e.g., sizes of individual crystals or particles), which may or may not overlap with other group sizes of a given embodiment. In some embodiments, the salt may be separated into groups by sieving or filtering. For example, the salt may be separated into a first group of particles having a first size, a second group of particles having a second size, and a third group of particles having a third size, with the second size larger than the first size, and the third size larger than the second size. With the particles separated by size, products formed from the various differently sized groups (e.g., coated salt particles or products including coated salt particles such as proppant mixes) may be used in different applications, or at different times or stages of a given application. For example, in embodiments where coated salt particles are used in proppant for hydraulic fracturing, proppant made from smaller sized particles may be injected first for deeper penetration into cracks in a formation, while proppant made from larger size particles may be subsequently injected. In some embodiments all of the salt may be separated into a group for further processing (e.g., coating) whereas in others some sizes may be retained for further processing and some sizes disposed of. It may be noted that drying may be performed in various embodiments because a generally wet salt may result from a desalination or crystallization process. Further, in some embodiments, the produced salt may include relatively large aggregates after the desalination or crystallization process, and the produced salt may be ground or otherwise processed or treated to provide smaller portions more appropriate for a desired end use (e.g., as an additive to proppant).

At 108, the produced salt is coated with resin to provide coated produced salt. One or more different resins may be employed in various embodiments. Examples of resin types that may be used in various embodiments include one or more of epoxy, phenol, furan, polyester, urea aldehyde, polyurethane, phenol aldehyde, vinyl ester, furfural alcohols, or furfural. Generally, resin may be used to inert the salts, for example, making the coated salts non-reactive or less reactive with a fluid (e.g., water) within which the coated salts will be added or mixed. For example, whereas un-coated salts may dissolve and/or go into suspension in a fluid, resin coated salts in accordance with various embodiments may not dissolve and/or go into suspension in the fluid. The coated salts are accordingly more compatible with fluids or other materials for use and/or disposal. For example, the coated salts may be used with a proppant mixture for hydraulic fracturing, as a cement additive, as a drilling fluid additive, or as heat treatment media (e.g., for quenching alloys).

As discussed above, in some embodiments, different groups may be made from differently sized salt particles. In the illustrated embodiment, at 110, the differently sized groups from 106 are separately or independently coated from each other, resulting in groups of coated salt particles, with each group differently sized from each other. For example, in some embodiments, a first coated group is provided by coating a first group of produced salt particles having a first size, a second coated group is provided by coating a second group of produced salt particles having a second size, and a third coated group is provided by coating a third group of produced salt particles having a third size, with the second size larger than the first size, and the third size larger than the second size. In some embodiments, the differently sized groups may be coated similarly to each other. In other embodiments, the differently sized groups may he coated differently (e.g., different resin type, coating thickness, and/or application technique based on size of particle being coated).

It may be noted that different techniques may be employed to apply the coating the salts in various embodiments. For example, at 112, resin is coated on the produced salt by spray coating. As another example, at 114, resin is coated on the produced salt by vapor deposition. As one more example, at 116, resin is coated on the produced salt by mixing the resin and produced salt.

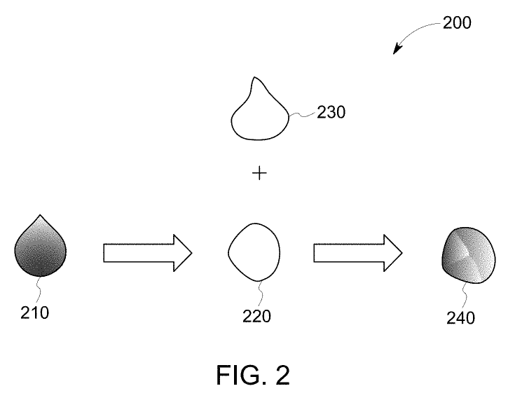

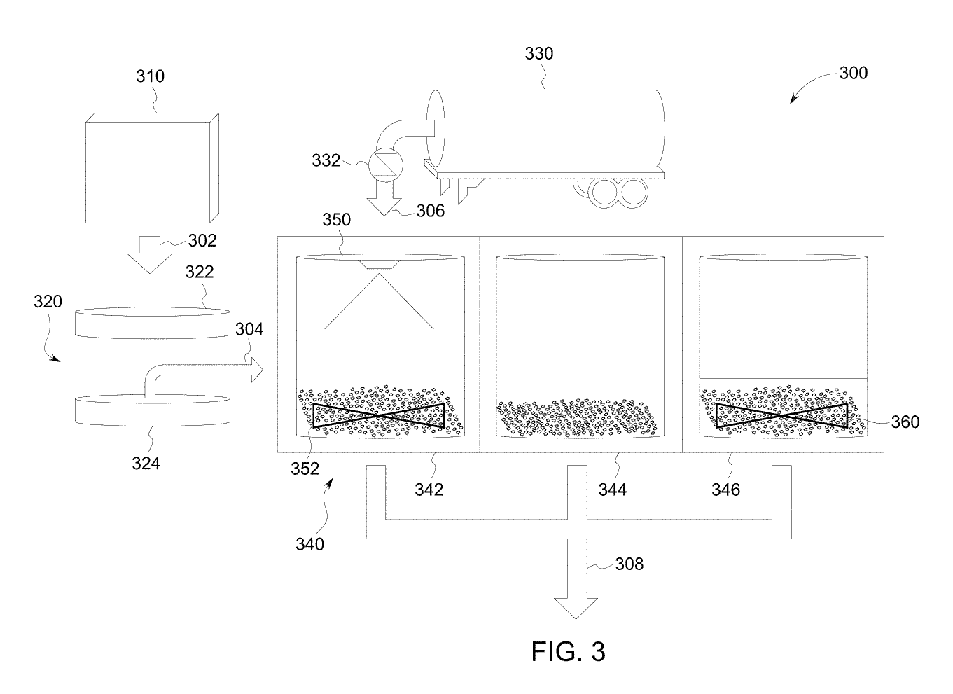

By way of summarizing certain steps as discussed herein, FIG. 2 provides a schematic depiction of a process 200 for providing a resin coated salt in accordance with various embodiments, and FIG. 3 provides a schematic depiction of a system 300 for coating a produced salt with resin. As seen in FIG. 2, produced water 210 is desalinated or crystallized to provide raw produced salt 220 and desalinated water 230. As discussed herein, the produced water may be obtained during an oil and/or gas drilling process. For example, oil, gas, and produced water 210 may be removed from a well, with the oil and gas sent for refining while the produced water 210 is desalinated. As also seen in FIG. 2, the raw produced salt 220 is coated with a resin to provide resin coated salt 240. As just one example, in some embodiments a resin coating between 15-30 micrometers thick may be provided, which provides about 3% resin by volume for produced salt that has been filtered using ASTM mesh sizes of 20 and 40 to select the produced salt from a mixed volume including other sizes of particles.

FIG. 3 provides a schematic depiction of a system 300 for coating a produced salt with resin. As seen in FIG. 3, the system 300 includes salt storage container 310, a filtering unit 320, a resin tank 330, and a coating unit 340. The salt storage container 310 in the depicted embodiment is used to store produced salt that has been separated from produced water that is a product of an oil and/or gas drilling process. The produced salt, for example, may include Sodium Chloride along with one or more of Calcium Sulfate, Calcium Chloride, Sodium Bicarbonate, Sodium Sulfate, Calcium Carbonate, or other salts or minerals.

In the illustrated embodiment, produced salt 302 from the salt storage container 310 is provided to the filtering unit 320. Generally, the filtering unit 320 is configured to remove undesired sizes of salt particles prior to a coating process. In the illustrated embodiment, the filtering unit 320 includes an upper sieve 322 having a relative larger mesh and a lower sieve 324 having a relatively smaller mesh than the upper sieve 322. Particles that pass through the upper sieve 322 but do not pass through the lower sieve 324 are used to provide filtered produced salt 304 which is provided to the coating unit 340. Accordingly, the upper sieve 322 may be used to exclude particles larger than desired from a coating process and the lower sieve 324 may be used to exclude particles smaller than desired from a coating process. In embodiments including multiple groups of differently sized particles, particles excluded from the filtered produced salt 304 may be further filtered to select other ranges of particle sizes for further processing (e.g., coating).

Along with the filtered produced salt 304, resin 306 is provided to the coating unit 340. The resin 306 is provided from the resin tank 330 via meter 332. In various embodiments, the resin 306 may be comprised of epoxy, phenol, furan, polyester, urea aldehyde, polyurethane, phenol aldehyde, vinyl esters, furfural alcohols, or furfural. It may be noted that the coating unit 340 is depicted schematically as including three different mixing units (spray coating unit 342, vapor deposition unit 344, and mixing unit 346); however, in practice the coating unit 340 may be configured for only one type of coating (e.g., the coating unit 340 may include one of the spray coating unit 342, vapor deposition unit 344, or mixing unit 346, but not the others). The type of application process may be selected based on the resin used in various embodiments. As seen in FIG. 3, the spray coating unit 342 includes a sprayer 350 configured to spray a resin onto salt particles. The spray coating unit 342 may also include a mixer 352 configured to change the orientation of particles for increased uniformity of application of resin sprayed onto the salt particles.

The vapor deposition unit 344 is configured to deposit resin in a vapor form onto salt. For example, the vapor deposition unit 344 may be configured to heat or otherwise evaporate resin for application onto the salt particles. The mixing unit 346 is configured to mix resin with the salt particles to apply the resin coating. For example, salt particles may be mixed with the resin and a liquid binder using an auger 360. After coating, resin coated salt 308 is removed from the coating unit 340 for further processing and/or use.

As discussed herein, the coated salt produced in various embodiments may be further advantageously employed in various practical applications, for example by adding a coated salt product with one more additional materials. In some embodiments, coated salt may be used in connection with the same oil or gas producing facility or location at which the produced water, from which the produced salt was separated, was initially obtained. For example, returning to FIG. 1, in the depicted embodiment, at 118, the coated salt is used at the same site at which the produced water was obtained at 102. Accordingly, the coated produced salt may be used for a subsequent drilling (and/or completion and/or production) process being performed at the same formation, site, or facility as an initial drilling (and/or completion and/or production) process from which the produced salt was originally obtained. For example, the produced salt used to make the coated salt may originate from the same formation with which the coated salt is subsequently used. Examples of uses of coated salt in connection with oil and/or gas drilling facilities include as a portion of a proppant mix for hydraulic fracturing, as part of drilling mix or mud, or as an additive to concrete used, for example, to fill gaps between a well bore and the ground from which the well bore was excavated. It may be noted that, as used herein, the same producing facility or location need not necessarily include the same well. For example, a given drilling (and/or completion and/or production) site, location, or facility may include a number of wells in the same general location as part of a network of wells. Coated salt produced by using produced water from one well (e.g., a more mature well in a production stage) may be used to provide proppant for hydraulic fracturing for a different well (e.g., a less mature well) in the same location, facility, or site.

For example, at 120 of the illustrated example, the coated produced salt is mixed with at least one of sand, resin coated sand, or a ceramic material to provide a proppant for hydraulic fracturing. The coated produced salt in some embodiments constitutes between 5% and 15%, by weight, of the proppant, with the sand and/or ceramic, along with other additives, constituting the remainder. Addition of the coated produced salt to other proppant materials provides a number of benefits in various embodiments. For example, use of resin coated salt may reduce the use (and associated cost) of sand or ceramic proppant usage. As another example, use of resin coated salt may provide an efficient, convenient salt disposal pathway, for example if the salt is returned to the same location or formation from which the produced water was initially obtained. Use of resin coated salt may also lower the density and improve proppant pack migration into a formation. Further, when the resin coated salt is used at the same location from which the produced water is obtained, the resin coated salt is local sourced, resulting in reduced transportation and handling time, cost, and expense.

The particular resin and/or method of application in various embodiments is selected to impart desired properties to the resulting coated produced salt for use in proppant applications. For example, the coated produced salt may be configured to provide desired fluid compatibility (e.g., to eliminate, minimize, or reduce dissolving of the coated produced salt in a fluid). Accordingly, the resin coated produced salt may provide improved stability in low purity acids, chemicals, or oils. Further, the resin coated produced salt may be configured to have a crush strength equal to or better than sand. For example, a resin coated produced salt may have a crush strength of 40 MegaPascals (MPa), compared to about 25 MPa of uncoated produced salt. Further, the produced salt may be sieved to an appropriate size for use with proppant. Example size ranges including sizes produced using an ASTM standard 16 size sieve as a lower limit and an ASTM standard 30 size sieve as an upper limit; an ASTM standard 20 size sieve as a lower limit and an ASTM standard 40 size sieve as an upper limit; an ASTM standard 30 size sieve as a lower limit and an ASTM standard 50 size sieve as an upper limit; or an ASTM standard 40 size sieve as a lower limit and an ASTM standard 70 size sieve as an upper limit, among others. Further, resin coated produced salt in various embodiments provides an improved shape factor via a uniform resin coating. Such a coating improves sphericity and roundness over uncoated salt crystals, and improves flow for improved packing, and improves stress distribution. Additionally, resin coated produced salt in various embodiments reduces turbidity, with resin encapsulation preventing generation of fines which may act to plug pore networks.

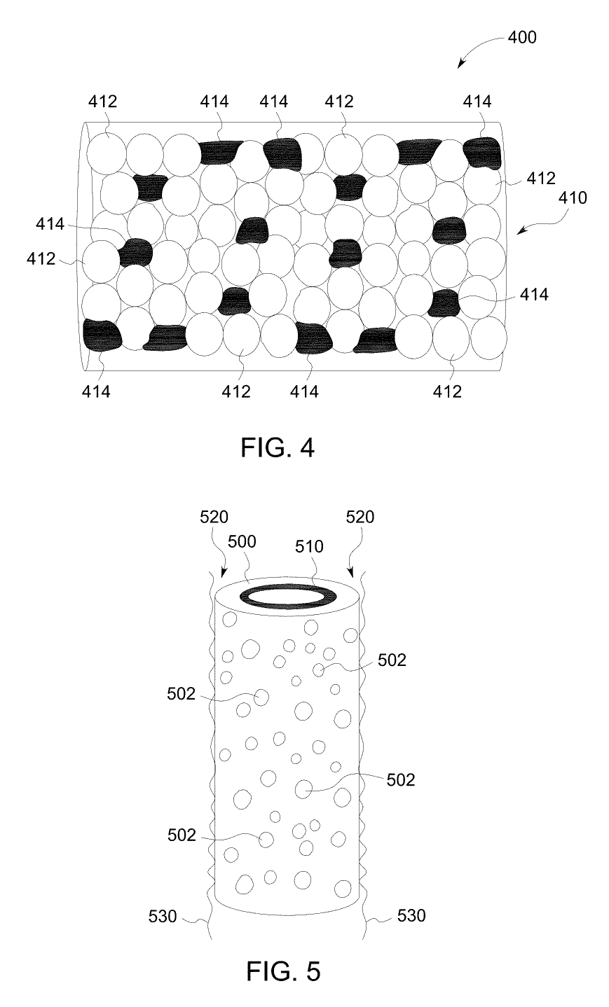

At 122 of the illustrated embodiment, the proppant provided at 120 is mixed with water to provide a fracturing fluid. At 124, the fracturing fluid is injected into a well to hydraulically fracture a portion of a formation (e.g., using a high pressure well). It may be noted that, when using salt originating from same formation, concerns or issues regarding salt disposal are reduced or eliminated, as the salt is returned to the same site or formation from which it originated. FIG. 4 provides a schematic depiction of proppant within a fracture of a formation in accordance with various embodiments. As seen in FIG. 4, a fracture 400 of a formation has been filled with proppant 410 that has been injected as part of a hydraulic fracturing process. The proppant 410 includes sand 412 and resin coated produced salt 414. For example, the resin coated produced salt 414 may form between 5-15% of the proppant 410 by weight. It may be noted that ceramic material, for example, may be used additionally or alternatively to the sand 412 in various embodiments.

With continued reference to FIG. 1, it may be noted that different sized particles of coated produced salt may be injected at different stages of a hydraulic fracturing process. The differently sized particles may be grouped by sizes and separately mixed with proppant and water to provide fracturing fluids for different stages of the process. For example, in the illustrated embodiment, at 126, a first coated group of particles having a first size is mixed with proppant and water to provide a first fracturing fluid, a second coated group of particles having a second size larger than the first size is mixed with proppant and water to provide a second fracturing fluid, and a third coated group of particles having a third size larger than the second size is mixed with proppant and water to provide a third fracturing fluid. Then, at 128, the first fracturing fluid is injected into the well, followed by the second fracturing fluid being injected into the well, which is then followed by the third fracturing fluid being injected into the well.

As another example, a resin coated produced salt may be used in making cement, which may be used at the same site or formation from which the produced salt was originally obtained. For example, such cement may be used in connection with wellpads, wellbores, or roads. In the illustrated embodiment, at 130, coated produced salt is used to provide cement. For example, the coated produced salt may be used to supplement other construction materials (e.g., as 5-15% by weight of the cement). At 132 of the depicted example, the cement formed at 130 is injected into a well site to fill a gap between a wellbore and an installation site. FIG. 5 provides a schematic depiction of cement used with a wellbore in accordance with various embodiments. As seen in FIG. 5, cement 500 surrounds a well-bore 510, filling in a gap 520 between the well-bore 510 and ground of the installation site 530. The cement 500 includes resin coated salt particles 502. The cement may be injected into the gap 520 by first being injected down the interior of the well-bore 510, and then passing upward along the exterior of the well-bore 510 to fill the gap 520. The cement produced using the coated produced salt provides several beneficial technical effects. For example, use of the coated produced salt with cement provides for a sustainable use of the coated salt which otherwise may be a waste byproduct. The resin encapsulated salt is stable in the cement mix, providing fluid compatibility. Further, the cement formed with resin coated produced salt has comparable strength to conventional cement aggregates.

Returning to FIG. 1, as yet another example, coated produced salt may be used in connection with drilling mud. In the illustrated embodiment, at 134, the coated produced salt is used to provide drilling mud. The coated produced salt may be mixed with drilling mud and used as an additive to drilling mud. At 136, the drilling mud formed at 134 is injected into a well during drilling. In various embodiments, the resin coated salt is compatible with water based muds and is suitable for low mud weight applications. Use of the coated produced salt, which is inert or does not dissolve in water, helps reduce dissolved solids for a desired mud weight. The coated produced salt has comparable strength to mud particulates, and helps conserve rheology of the fluid, as high dissolved solids are not required to increase mud weight. Further still, as discussed herein, the coated produced salts may be locally sourced relative to the well in which the drilling mud is to be used.

It may be noted that, in other embodiments, the coated produced salt may be used at a different location or in connection with a different applicant than drilling. For example, in the illustrated embodiment, at 138, the coated produced salt is used for alloy quenching. The coated produced salt may be used as a heat treatment medium, such as a quench medium for alloy manufacturing. Coated produced salt baths may be used, with the inert characteristics of the resin coated produced salt preventing or reducing the formation of oxides during quenching. Coated produced salts in various embodiments provide high temperature tolerances (e.g., 450-1100 degrees Fahrenheit) for metallurgical applications such as quenching.

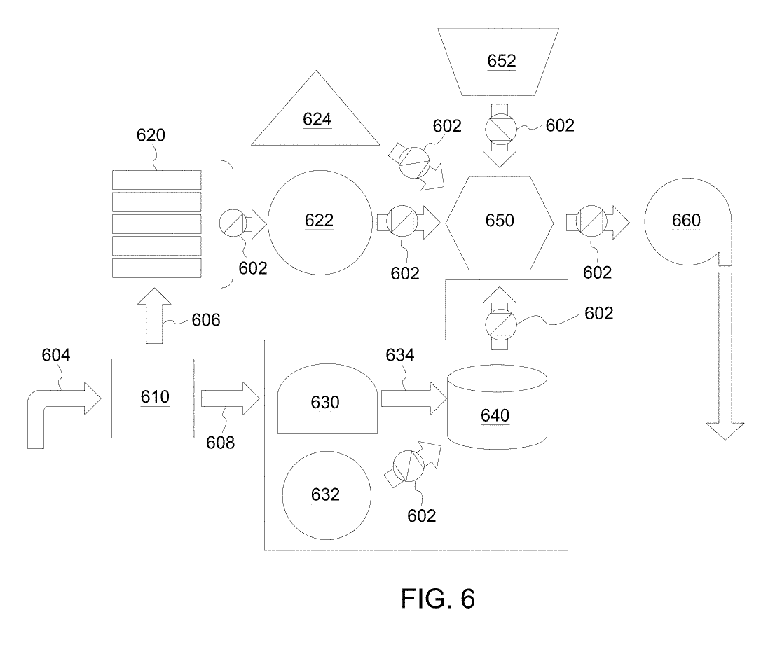

FIG. 6 is a schematic diagram of a system 600 formed in accordance with various embodiments. In various embodiments, some or all of the components of the system 600 may be located at the same drilling site or location (e.g., a drilling site including multiple wells). It may be noted that a drilling site, as used herein, may also include a completion site and/or production site, as oil or gas are produced from a well that has been drilled. As seen in FIG. 6, the system 600 includes a desalination unit 610, a water storage tank 620, a salt storage tank 630, a coating unit 640, a proppant mixer 650, and a pump 660. Meters 602 are disposed between various components of the system 600 for control of the flow of various materials.

The desalination unit 610 of the depicted embodiment is configured to receive produced water 604 from a drilling site (and/or completion site and/or production site), and to separate the produced water 604 into treated or desalinated water 606 and produced salt 608. The desalination unit 610, for example, may include an evaporator and/or crystallizer. The treated or desalinated water 606 in the illustrated embodiment is sent to the water storage tank 620 for storage. Water from the storage tank 620 may be used to provide a fracturing fluid and/or for other purposes at the site. The produced salt 608 in the illustrated embodiment is stored at the salt storage tank 630.

Produced salt from the salt storage tank 608, along with resin from the resin tank 632, is provided to the coating unit 640. The coating unit 640 may also be referred to as a resin applicator. The coating unit 640 is configured to apply a resin coating to the produced salt to provide coated produced salt. It may be noted that a filtering unit 634 may be used to control the size of coated produced salt particles provided to the coating unit 640. The filtering unit 634, for example, may include one or more sieves. (For additional discussion regarding coating, see, e.g., FIG. 3 and related discussion.)

Coated produced salt from the resin application 640 is provided to the proppant mixer 650. The proppant mixer 650 of the depicted embodiment also receives proppant material (e.g., sand and/or ceramic) from the proppant storage tank 652, and water from the water storage tank 620. Various chemicals and/or additives may be added to the water and/or fracturing fluid using chemical mixer 622 and/or additive storage 624. For example, in various embodiments, proppant may be mixed with water and one or more of cross linkers, pH control chemicals, clay stabilizers, friction reducers, gelling agents, surfactants, or breakers. The proppant mixer 650 is configured to mix the coated produced salt with water as well as ceramic and/or salt to provide a fracturing fluid for hydraulic fracturing. The fracturing fluid is provided to the pump 660. The pump 660 in the illustrated embodiment is a high pressure pump configured to inject the fracturing fluid into a well.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation.

It should be noted that the particular arrangement of components (e.g., the number, types, placement, or the like) of the illustrated embodiments may be modified in various alternate embodiments. For example, in various embodiments, different numbers of a given module or unit may be employed, a different type or types of a given module or unit may be employed, a number of modules or units (or aspects thereof) may be combined, a given module or unit may be divided into plural modules (or sub-modules) or units (or sub-units), one or more aspects of one or more modules may be shared between modules, a given module or unit may be added, or a given module or unit may be omitted.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. A method comprising:
obtaining produced water from at least one of drilling, completion or hydrocarbon production;
separating the produced water into desalinated water and produced salt; and
coating the produced salt with resin to provide coated produced salt.

2. The method of claim 1, wherein the resin is coated on the produced salt by at least one of spray coating, vapor deposition, or mixing.

3. The method of claim 1, further comprising mixing the coated produced salt with at least one of sand, resin coated sand, or a ceramic material to provide a proppant for hydraulic fracturing.

4. The method of claim 3, further comprising mixing the proppant with water to provide a fracturing fluid, and injecting the fracturing fluid into a well to hydraulically fracture a portion of a formation.

5. The method of claim 4, wherein the produced salt originates from the formation.

6. The method of claim 4, further comprising:
drying and sizing the produced salt into a first group having a first size, a second group having a second size that is larger than the first size, and a third group having a third size that is larger than the second size before coating the produced salt, wherein coating the produced salt provides a first coated group corresponding to the first size, a second coated group corresponding to the second size, and a third coated group corresponding to the third size;
separately mixing the first coated group, second coated group, and third coated group with proppant and water to provide a corresponding first fracturing fluid, second fracturing fluid, and third fracturing fluid;
injecting the first fracturing fluid into a well;
injecting the second fracturing fluid into the well after the first fracturing fluid; and
injecting the third fracturing fluid into the well after the second fracturing fluid.

7. The method of claim 1, further comprising using the coated produced salt to provide cement.

8. The method of claim 7, further comprising injecting the cement to fill a gap between a well-bore and an installation site.

9. The method of claim 1, further comprising using the coated produced salt to provide a drilling mud.

10. The method of claim 9, further comprising injecting the drilling mud into a well during drilling.

11. The method of claim 1, further comprising using the coated produced salt for alloy quenching.

12. A method comprising:
obtaining a coated produced salt, the coated produced salt comprising a resin coating a produced salt originating from at least one of an initial drilling process, an initial completion process, or an initial hydrocarbon production process;
using the coated produced salt for at least one of a subsequent drilling process, subsequent completion process, or a subsequent hydrocarbon production process being performed in at least one of a same formation, site, or facility as the at least one of the initial drilling process, initial completion process, or the initial hydrocarbon production process.

13. The method of claim 12, further comprising:
mixing the coated produced salt with at least one of sand, resin coated sand, or a ceramic material to provide a proppant for hydraulic fracturing;
mixing the proppant with water to provide a fracturing fluid; and
injecting the fracturing fluid into a well.

14. The method of claim 13, wherein the coated produced salt comprises a first coated group having a first size, a second coated group having a second size that is larger than the first size, and a third coated group having a third size that is larger than the second size, the method further comprising:
separately mixing the first coated group, second coated group, and third coated group with the proppant and the water to provide a corresponding first fracturing fluid, second fracturing fluid, and third fracturing fluid;
injecting the first fracturing fluid into the well;
injecting the second fracturing fluid into the well after the first fracturing fluid; and
injecting the third fracturing fluid into the well after the second fracturing fluid.

15. The method of claim 12, further comprising:
using the coated produced salt to provide cement; and
injecting the cement to fill a gap between a well-bore and an installation site.

16. The method of claim 12, further comprising:
using the coated produced salt to provide a drilling mud; and
injecting the drilling mud into a well during drilling.

17. A system comprising:
a desalination unit configured to receive produced water from at least one of drilling, completion, or hydrocarbon production and to separate the produced water into desalinated water and produced salt;
a water storage tank for storing the desalinated water;
a salt storage tank for storing the produced salt; and
a coating unit configured to apply a resin coating to the produced salt to provide coated produced salt, wherein the desalination unit and the coating unit are disposed at at least one of a common site or facility.

18. The system of claim 17, further comprising a proppant mixer configured to mix the coated produced salt with water and at least one of sand, resin coated sand, or ceramic to provide a fracturing fluid for hydraulic fracturing.

19. The system of claim 18, further comprising a pump configured to inject the fracturing fluid into a well.

20. The system of claim 17, further comprising a filtering unit configured to separate the produced salt into two or more groups based on size before the resin coating is applied.
